(19) United States
(12) Patent Application Publication
(10) Pub. No.: US 2020/0069507 A1
(43) Pub. Date: Mar. 5, 2020

(54) FOOT THERAPY DEVICE

(71) Applicants: Jennifer Muroff, New York, NY (US); Michael Bertan, Scarsdale, NY (US)

(72) Inventors: Jennifer Muroff, New York, NY (US); Michael Bertan, Scarsdale, NY (US)

(21) Appl. No.: 16/453,218

(22) Filed: Jun. 26, 2019

Related U.S. Application Data
(60) Provisional application No. 62/697,460, filed on Jul. 13, 2018.

(51) Int. Cl. A61H 7/00

(52) U.S. Cl. CPC A61H 7/002; A61H 2201/1695; A61H 2205/125

(57) ABSTRACT

A therapeutic device which engages the sole of the foot of the user includes a lower base and an ellipsoidal upper surface having a plurality of nubs or spikes radially extending outwardly from the ellipsoid. The base and the upper ellipsoidal surface have different hardnesses, the upper surface being softer than the lower surface. The upper surface is partially compressible when a user stands thereon, and exerts an upward force on the sole of the user.

### CROSS-REFERENCE TO RELATED APPLICATION

This application is a completion application which claims the priority benefit of co-pending U.S. Provisional Patent Application Ser. No. 62/698,460, filed Jul. 13, 2018, for “Foot Therapy Device,” the disclosure of which is hereby incorporated by reference in its entirety, including the drawing.

### BACKGROUND OF THE INVENTION

### 1. Field of the Invention

The present invention pertains to exercise devices. More particularly, the present invention concerns therapeutic exercise devices. Even, more particularly, the present invention concerns therapeutic foot-related exercise devices.

### 2. Prior Art

In U.S. Pat. No. 7,485,102 there is disclosed a device for foot therapy which, generally, comprises a domed-shaped device, having a planar bottom, which when stood on, engages the sole of a foot to enable the user to apply pressure thereto to impart a therapeutic exercise.

According to the aforementioned patent, by placing selected portions of the sole of the foot on the dome and asserting pressure thereagainst certain therapeutic effects are achieved thereby. The device is made from a resilient material which compresses but does not collapse when pressure is applied thereto.

It is to be appreciated that by virtue of the domed configuration, depending on the size of the sole of the user inadequate area can be occasioned by the use of the device.

Furthermore, again, depending on the size of the foot and sole of the user, an undue amount of time may be necessary to fully enjoy the effects of the device.

As is disclosed hereinafter the present invention improves upon the aforementioned device by providing a larger surface area for exerting therapeutic pressure against the sole of the user and at the same time providing a more effective therapeutic effect.

### SUMMARY OF THE INVENTION

In accordance with the present invention there is provided a therapeutic device particularly adapted for engaging the sole of the foot of a user and which, generally, comprises:

(a) a substantially non-resilient base and (b) an ellipsoidal upper convex surface having a plurality of protuberances extending radially outwardly from the upper surface.

The protuberances are arranged and define a plurality of nubs or spikes.

The base and the upper surface are frictionally fitted together.

A bead or lip extends around the periphery of the device at the joint between the lower planar surface or base and the ellipsoidal upper convex surface.

The device is a substantially solid and, preferably, made from a PVC gel. The upper surface and the base have different hardnesses.

The device is deployed and used by placing it on a floor or other horizontal surface. The user, either from a sitting position or a standing position, places his or her foot thereatop and exerts pressure on the convex surface which, in turn, creates an opposite therapeutic pressure against selected portions of the heel and/or sole depending on placement of the foot.

For a more complete understanding of the present invention reference is made to the following detailed description and accompanying drawing.

In the drawing like reference characters refer to like parts throughout the several views in which:

### BRIEF DESCRIPTION OF THE DRAWINGS

FIG. 1 is a perspective view of the therapeutic device hereof;

FIG. 2 is a top view of the therapeutic device hereof;

FIG. 3 is a bottom plan view thereof; and

FIG. 4 is a cross-sectional view taken along line 4-4 of the FIG. 2.

FIGS. 5-12 depict various positions for foot placement in using the present device.

### DETAILED DESCRIPTION OF THE INVENTION

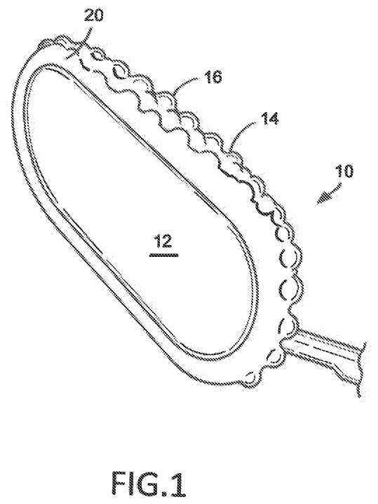

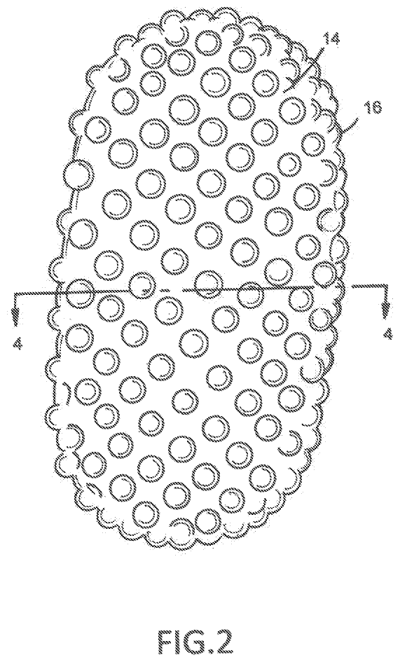

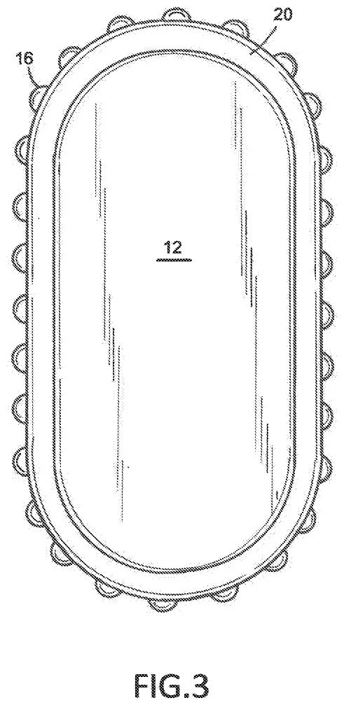

Now, and with reference to the drawing and in particular, FIGS. 1-3, there is depicted therein a therapeutic device particularly adapted for imparting therapy to a user's foot and, generally, denoted at 10.

The device 10 generally comprises a substantially planar base 12 and an ellipsoidal convex upper surface 14. A plurality of spatially arranged nubs or spikes or protuberances 16 which project outwardly from the convex upper surface 14 and are integrally formed with the upper surface 14.

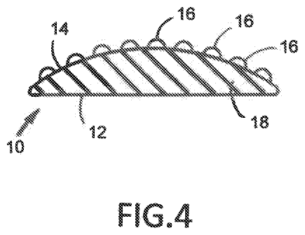

As particularly shown in FIG. 4, the device 10 is a substantially solid member having a solid core 18.

The upper convex surface is formed from a resilient, partially compressible material, such as a polyvinyl chloride (PVC). PVCs are well known and commercially available, polymeric materials, such as those sold by CNSG Jilantai Polymers Materials Co., Ltd. These PVC materials can be molded to different hardnesses.

Preferably, the PVC used herein is molded from a PVC liquid which becomes a gel when heated in the mold.

In practicing the present invention, the PVC gel or liquid used to prepare the upper surface is molded to a first hardness.

The nubs or spikes, as noted, project radially outwardly from the upper convex surface and are integral with the upper surface and molded therewith. The engaged portion of the sole which is in contact with the nubs, exert a therapeutic effect against that portion of the sole in contact therewith.

The base is formed from the same PVC gel or a different polymeric material and molded to a second or different hardness than that of the upper surface.

A bead or lip 20 is provided at the juncture between the base 12 and the upper surface 14.

The present device hereof is manufactured by injection molding the polyvinyl chloride, as a liquid, in a suitable mold. The mold is, preferably, a two-part or piece mold in which the liquid is injected by any suitable means through a sealable port. In the mold, the PVC liquid, under heat, becomes gel-like.

Once the PVC is injected into the mold and the port is sealed, the mold is spun anywhere from about 60 to 120 seconds while maintained at about 275° to about 325° C.

Next, the mold is opened and the upper surface component is removed therefrom. Because the upper surface is at an elevated temperature when the mold is opened, it is in a somewhat flexible state.

The PVC used to manufacture the upper has a durometer reading of about 70.

The base is, likewise, injection molded from a PVC liquid but is molded to a hardness having a durometer reading of about 90.

After molding, the base is removed from the mold. Since the upper surface is still in a semi-flexible state the base and the upper are press-fitted together while the two parts are still being cured.

The lower surface or base is fixedly joined or fitted to the upper convex surface by friction, although they may be joined by sonic welding, fusion or the like.

In manufacturing the present device the upper convex surface and the base may have a colorant added to the PVC liquid for aesthetic purposes.

It should be noted that the upper convex part is a solid piece as is the base.

In molding the present parts, due to the heat in the mold, as the base is removed from the mold, a hole is poked into the base after the mold is opened to let the hot air inside the mold escape.

In manufacturing the device, generally, the convex upper surface has a ratio of diameter to length of about 1.5:1 to about 2.0:1 to achieve optimum results based upon the average size of the foot.

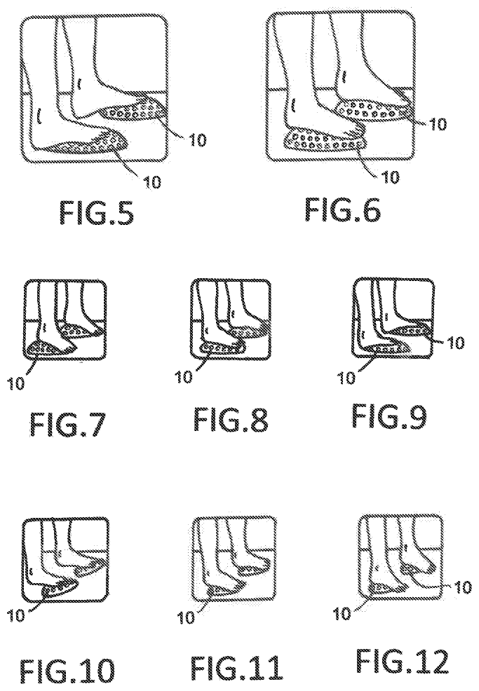

Referring now to FIGS. 5-12, the utilization of the device is shown. In use, the heel of a user is urged into contact with the upper surface either from a sitting position, such as while sitting in a chair, or by standing thereon. Because of the surface area provided for contact, sufficient upward force is generated such that substantially an entire sole can be effectively treated during one therapy session.

It should be noted that in deploying the device, it can be used alone or preferably, as a pair so that the user can stand on two devices at a single time.

The device hereof is useful in resolving many foot/sole issues including relief from plantar fasciitis, as well as, bunion and hammer toe relief.

To use the device, the user can be barefoot or in socks. When standing, the user can place his or her hands on a desk or wall to maintain balance.

As shown in FIG. 5, with a pair of devices, the user initially stands hip-width apart and places the balls of the feet on the device with the heels placed on the floor behind. The user leans slightly forward. This results in a gentle stretch in the calves and/or the back of the knees. When held in this position for about thirty to about sixty seconds there is relief from plantar fasciitis.

Referring to FIG. 6, the user, assuming the same hip-width apart and with the device positioned lengthwise, places the middle of his or her feet on the top of the upper surface such that the feet are not touching the floor. By shifting weight back and forth from the left foot to the right foot, core strengthening is achieved as the body tries to maintain balance. Optimally, the user starts a 30 second workout and works up to sixty seconds.

FIGS. 7-9 show the exercises for bunion and hammer toe relief. Here, the user assumes a hip-width apart stance and the devices are positioned lengthwise. Next, the user places his or her heels on the top surface with their toes on the floor frontward of the device. By pressing his or her weight into the top surface, while keeping as much pressure as is comfortable for thirty to sixty seconds, the desired relief is obtained.

Thereafter, the user walks his or her feet backwards to place the feet such that the middle of a foot is on top of the upper surface with no part of the foot touching the floor. By shifting weight back and forth from the left foot to the right foot and by keeping as much pressure on the feet as is comfortable for thirty to sixty seconds, the desired relief is achieved.

Also, by placing one's heels on the floor behind the device with his or her toes on the top of the upper surface and by leaning forward for thirty to sixty seconds and stretching and wiggling the toes, a deep stretch in the Achilles tendon is achieved.

As shown in FIGS. 10-12, for circulation and massage, the user positions the device hip-width apart and widthwise. When standing, the user places his or her toes on top of the upper surface and the heels off of the device (FIG. 10) and presses his or her weight into the upper surface for thirty to sixty seconds.

As shown in FIG. 11, the user moves his or her feet forward, standing with the middle of his or her feet on the top of the devices with his or her toes and heels off the ground, while pressing their body into the upper surface for thirty to sixty seconds.

Thereafter, and as shown in FIG. 12, the user places his or her heels on the top of the upper surface with their toes on the floor frontward while pressing into the device for thirty to sixty seconds.

The same exercises that are in the standing series may be completed while sitting.

It is to be readily appreciated that the contact area of the upper surface is sufficiently large enough such an entire sole can be effectively treated during one therapy session. When pressure is applied by a user standing or pressing against the upper surface, it compresses sufficiently to exert an equal and opposite force against that portion of the sole that is in contact therewith without being complete compressed.

### LISTING OF REFERENCES

10 device
12 base
14 upper surface
18 core
20 lip

Having, thus, described the invention what is claimed is:

1. A therapeutic device, comprising:
(a) a substantially non-resilient planar lower surface base defining a lower surface; and
(b) an ellipsoidal upper convex surface having a plurality of protuberances extending radially outwardly from the upper surface.

2. The device of claim 1 wherein the protuberances are spatially arranged on the upper surface for engaging the sole of the foot of a user.

3. The device of claim 2 wherein the protuberances define a plurality of nubs.

4. The device of claim 1 wherein:
the base of the upper surface are frictionally fitted together.

5. The device of claim 1 wherein the upper surface and the base have different hardnesses.

6. The device of claim 5 wherein the upper surface has a durometer hardness of about 70 and the base has a durometer hardness of about 90.

7. The device of claim 5 wherein the device is a PVC device.

8. The device of claim 1 wherein further comprising a bead extending around the periphery of the device at the joint between the lower planar surface and the ellipsoidal upper convex surface.

9. The device of claim 1 wherein the upper surface has a length to width ratio of from about 1.5:1.0 to about 2.0:1.0.
